(19) United States
(12) Patent Application Publication
(10) Pub. No.: US 2003/0218396 A1
(43) Pub. Date: Nov. 27, 2003

(54) Fan motor mounting structure for ceiling fan

(76) Inventor: Frank Hsieh, Taichung Hsien (TW)

Correspondence Address: PRO-TECHTOR INTERNATIONAL, 20775 Norada Court, Saratoga, CA, 95070-3018, US

(21) Appl. No.: 10/152,963

(22) Filed: May 21, 2002

(51) Int. Cl. H02K 5/00; H02K 7/08

(52) U.S. Cl. 310/89; 310/90

(57) ABSTRACT

A fan motor mounting structure, is constructed to include a stator, a rotor, a holder frame disposed at one side of the stator, the holder frame having an inside recess adapted for receiving the stator and the rotor, and an axle bearing assembly mounted inside the holder frame and adapted for supporting the stator, for enabling the stator to be freely rotated on the axis thereof.

### BACKGROUND OF THE INVENTION

1. Field of the Invention

The present invention relates to a ceiling fan and, more particularly, to a fan motor mounting structure for ceiling fan.

2. Description of the Related Art

FIG. 1 shows a fan motor for ceiling fan according to the prior art. According to this design, the fan motor is generally comprised of a top cover shell A, a bottom cover shell B, a first axle bearing A1 mounted in the top cover shell A, a second axle bearing B1 mounted in the bottom cover shell B, a stator C supported in the axle bearings A1;B1 between the cover shells A;B, and a rotor D mounted in between the cover shells A;B for free rotation with the cover shells A;B relative to the stator C. The precision requirement of the parts of this structure of fan motor is critical. If the parts do not fit one another precisely, a high noise will be produced during the operation of the fan motor. Because of critical precision requirement, the fabrication of this structure of fan motor is complicated. Further, the cover shells A;B has air vents for dissipation of heat. However, the centrifugal force produced during rotary motion of the rotor expels surrounding cold air, i.e., outside cold air is not guided into the inside of the fan motor to cool down the temperature.

### SUMMARY OF THE INVENTION

The present invention has been accomplished to eliminate the aforesaid drawbacks. It is the main object of the present invention to provide a fan motor mounting structure for ceiling fan, which is inexpensive to manufacture and easy to install. It is another object of the present invention to provide a fan motor mounting structure, which fits US Energy Start definitions. According to one aspect of the present invention, the fan motor mounting structure comprises a stator, a rotor, a holder frame disposed at one side of the stator, the holder frame having an inside recess adapted for receiving the stator and the rotor, and an axle bearing assembly mounted inside the holder frame and adapted for supporting the stator, for enabling the stator to be freely rotated on the axis thereof. According to another aspect of the present invention, the holder frame comprises a plurality of flow guide fins spaced around the periphery thereof and defining a plurality of flow guide ways adapted for guiding outside cold air into the inside of the holder frame. According to still another aspect of the present invention, the rotor comprises a plurality of flow guide fins extended from a top sidewall thereof around the border thereof and defining a plurality of flow guide ways adapted for guiding hot air out of the inside space of the holder frame to the outside.

### BRIEF DESCRIPTION OF THE DRAWINGS

FIG. 1 is a perspective view of a fan motor for ceiling fan according to the prior art.

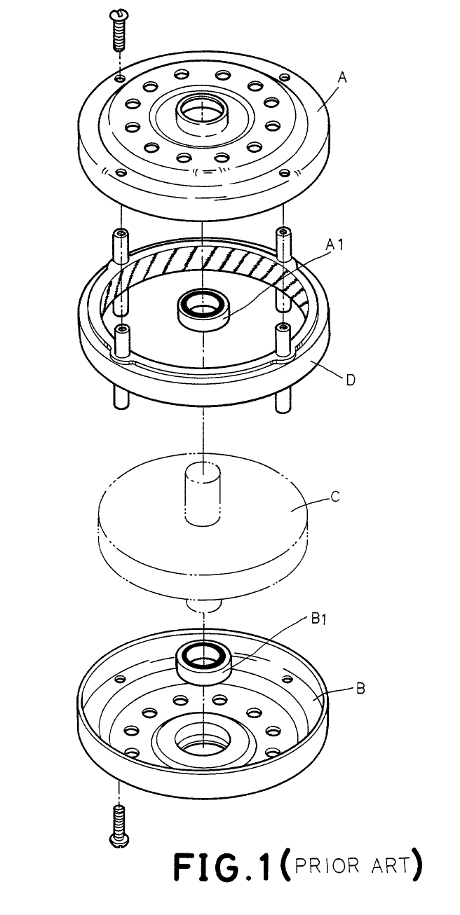

FIG. 2 is a sectional assembly view of a fan motor mounting structure according to a first embodiment of the present invention.

FIG. 3 is a bottom view of the fan motor mounting structure according to the first embodiment of the present invention.

FIG. 4 is a top view of the rotor for the fan motor mounting structure according to the first embodiment of the present invention.

FIG. 5 is a sectional assembly view of a fan motor mounting structure according to a second embodiment of the present invention.

FIG. 6 is a sectional assembly view of a fan motor mounting structure according to a third embodiment of the present invention.

### DETAILED DESCRIPTION OF THE PREFERRED EMBODIMENT

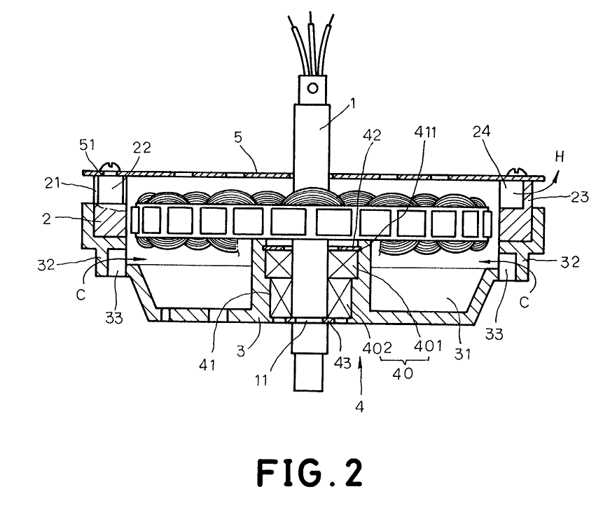

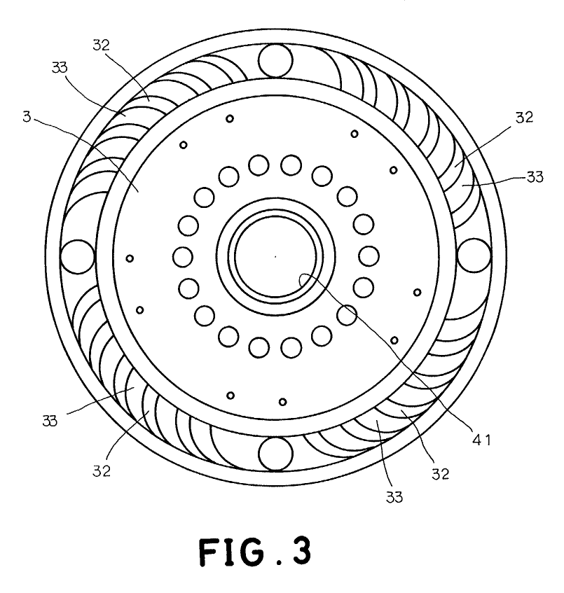

Referring to FIGS. 2 and 3, a fan motor mounting structure for ceiling fan is shown comprising a stator 1, a rotor 2 disposed around the stator 1, a holder frame 3 disposed at one side of the rotor 2, an axle bearing assembly 4, and a flat top cover 5.

The stator 1 is a cylindrical member having an annular groove 1 extended around the periphery near the bottom end thereof. The holder frame 3 has an inside recess 31, which receives the stator 1 and the rotor 2. The axle bearing assembly 4 is comprised of a bearing block 41 mounted inside the inside recess 31, and at least one axle bearing 40 mounted in the bearing block 41 to support the stator 1, for enabling the stator 1 to be freely rotated on its own axis. The bearing block 41 comprises an inside annular groove 411 extended around the inside wall near the top. A C-shaped retainer 42 is fastened to the inside annular groove 411 to secure the at least one axle bearing 40 in place.

The axle bearing assembly 4 may be variously embodied. According to the embodiment shown in FIG. 2, the bearing block 41 is a stepped receptacle holding a big axle bearing 401 and a small axle bearing 402. During installation, the small axle bearing 402 is mounted in the lower side inside the stepped bearing block 41, and then the big axle bearing 401 is mounted in the upper side inside the stepped bearing block 41, and then the C-shaped retainer 42 is fastened to the inside annular groove 411 to secure the big axle bearing 401 and the small axle bearing 402 in place. After installation of the stator 1 in the axle bearing assembly 4 inside the holder frame 3, a second C-shaped retainer 43 is fastened to an outside annular groove 11 to secure the stator 1 in place.

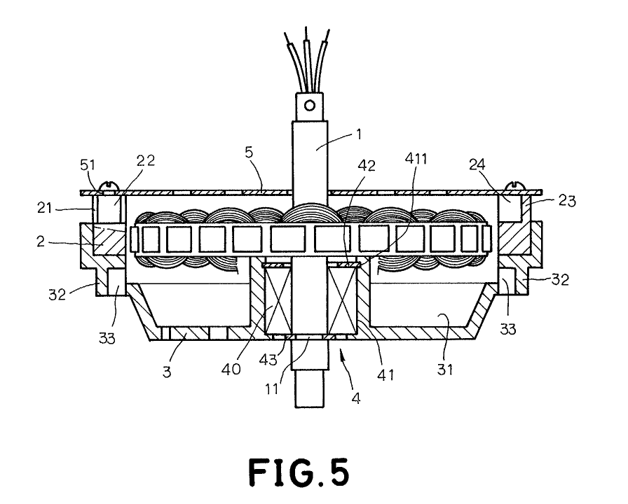

According to an alternate form of the present invention as shown in FIG. 5, the bearing block 41 is shaped like a barrel, holding one single axle bearing 40. The height (axial length) of the axle bearing 40 is much greater than regular axle bearings for ceiling fans.

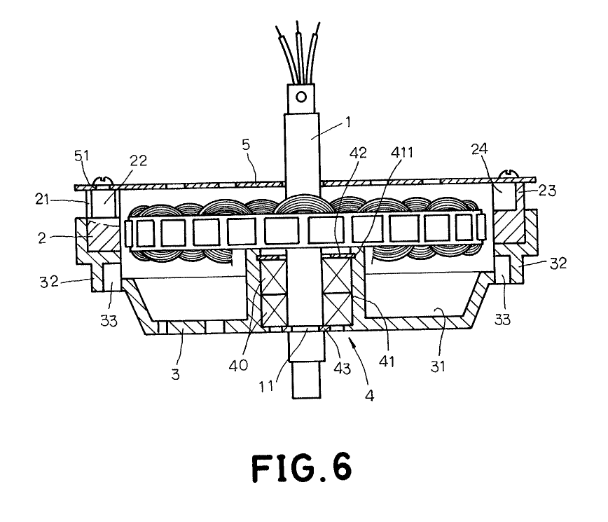

According to another alternate form of the present invention as shown in FIG. 6, the bearing block 41 is shaped like a barrel, holding two axle bearings 40 of equal size at different elevations. The height (axial length) of the axle bearings 40 is same as regular axle bearings for ceiling fans.

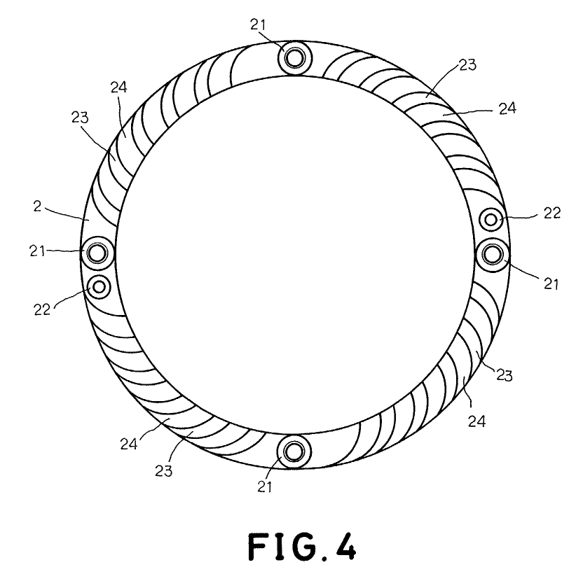

Referring to FIG. 4 and FIG. 2 again, the stator 2 comprises a plurality of upright nuts 21 equiangularly disposed at the top around the border thereof. The flat top cover 5 is supported on the upright nuts 21 of the stator 2 and fixedly secured thereto by screws. The stator 2 further comprises a plurality of upright guide rods 22 respectively disposed adjacent the upright nuts 21 and adapted for inserting into respective guide holes 51 to guide installation of the flat top cover 5 in the stator 2.

Referring to FIGS. from 2 through 4 again, the holder frame 3 comprises a plurality of flow guide fins 32, defining a plurality of flow guide ways 33 in between each two adjacent flow guide fins 32 in communication with the inside space of the holder frame 3. The stator 2 comprises a plurality of flow guide fins 23 extended from the top sidewall around the border, defining a plurality of flow guide ways 23 in between each two adjacent flow guide fins 23. During the operation of the ceiling fan, outside cold air C is guided into the inside of the fan motor mounting structure through the flow guide ways 33 in the holder frame 3, and then guide out of the fan motor mounting structure through the flow guide ways 23 in the stator 2 to carry heat H away from the inside of the fan motor mounting structure to the outside space. Because heat is quickly efficiently dissipated from the fan motor mounting structure during the operation of the ceiling fan, the service life of the fan motor of the ceiling fan is greatly prolonged. Further, good ventilation in the fan motor mounting structure greatly saves power consumption of the fan motor.

A prototype of fan motor mounting structure for ceiling fan has been constructed with the features of FIGS. 2˜6. The fan motor mounting structure for ceiling fan functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A fan motor mounting structure comprising:
a stator;
a rotor;
a holder frame disposed at one side of said stator, said holder frame comprising an inside recess adapted for receiving said stator and said rotor; and
an axle bearing assembly mounted inside said holder frame and adapted for supporting said stator, for enabling said stator to be freely rotated on the axis thereof.

2. The fan motor mounting structure as claimed in claim 1, wherein said rotor comprises a plurality of upright nuts equiangularly disposed at a top side thereof, and a flat top cover supported on and fixedly fastened to said upright nuts.

3. The fan motor mounting structure as claimed in claim 2, wherein said flat top cover comprises a plurality of guide holes, said rotor comprises a plurality of upright guide rods respectively disposed adjacent said upright nuts and adapted for inserting into said guide holes of said flat top cover to guide installation of said flat top cover in said stator.

4. The fan motor mounting structure as claimed in claim 1, wherein said axle bearing assembly comprises a hollow bearing block mounted inside said inside recess of said holder frame, and at least one axle bearing mounted inside said hollow bearing block.

5. The fan motor mounting structure as claimed in claim 4, wherein said bearing block is shaped like a barrel, and the number of said at least one axle bearing is one.

6. The fan motor mounting structure as claimed in claim 4, wherein the number of said at least one axle bearing is two.

7. The fan motor mounting structure as claimed in claim 4, wherein said bearing block is a stepped receptacle.

8. The fan motor mounting structure as claimed in claim 7, wherein said at least one axle bearing includes two axle bearings of different outer diameters respectively mounted in said stepped receptacle at different elevations.

9. The fan motor mounting structure as claimed in claim 1, wherein said holder frame comprises a plurality of flow guide fins spaced around the periphery thereof and defining a plurality of flow guide ways adapted for guiding outside cold air into the inside of said holder frame.

10. The fan motor mounting structure as claimed in claim 1, wherein said rotor comprises a plurality of flow guide fins extended from a top sidewall thereof around the border thereof and defining a plurality of flow guide ways adapted for guiding hot air out of the inside space of said holder frame to the outside.

11. The fan motor mounting structure as claimed in claim 1, wherein said bearing block comprises an inside annular groove extended around an inside wall thereof near a top side, and a C-shaped retainer fastened to said inside annular groove to secure said at least one axle bearing to the inside of said bearing block.

12. The fan motor mounting structure as claimed in claim 1, wherein said stator comprises an outside annular groove extended around the periphery thereof near a bottom side, and a C-shaped retainer fastened to said outside annular groove to secure said stator to said holder frame.
